(19) United States
(12) Patent Application Publication
(10) Pub. No.: US 2021/0341665 A1
(43) Pub. Date: Nov. 4, 2021

(54) BACKLIGHT MODULE AND DISPLAY DEVICE THEREOF

(71) Applicant: WUHAN CHINA STAR OPTOELECTRONICS TECHNOLOGY CO., LTD., Wuhan, Hubei (CN)

(72) Inventor: Gege ZHOU, Wuhan, Hubei (CN)

(21) Appl. No.: 16/612,134

(22) PCT Filed: Jul. 18, 2019
(86) PCT No.: PCT/CN2019/096456

§ 371 Date: Nov. 8, 2019

(30) Foreign Application Priority Data
Nov. 28, 2018 (CN) 201811436609.8

(51) Int. Cl. F21V 8/00

(52) U.S. Cl. CPC G02B 6/0068; G02B 6/0053; G02B 6/0051; G02B 6/0088

(57) ABSTRACT

A backlight module and a display device thereof are provided. The backlight module includes a light guide plate, a frame body, and a light source. The frame body is disposed around the light guide plate. The light source is disposed between the light guide plate and the frame. A via hole defined on the light guide plate. An outer convex is disposed on a side plate of the light guide plate away from the light source behind the via hole, and/or an inner recess is disposed on a side frame of the frame body away from the light source behind the via hole.

### BACKGROUND OF INVENTION

### Field of Invention

The present invention relates to the field of display technology, more particularly, to a backlight module and a display device thereof.

### Description of Prior Art

With the continuous development of liquid crystal display technology, the application fields of liquid crystal displays, especially color liquid crystal displays, are also expanding. Driven by the liquid crystal display market, the backlight industry has a booming scene. A liquid crystal display is a passive light emitting element, and the liquid crystal display itself does not emit light, but it is illuminated by a backlight module below the display. The backlight system and the liquid crystal display are combined to form a liquid crystal display module. The liquid crystal backlight is a flat uniform illumination device. A cold cathode fluorescent tube or light emitting diode (LED) strip served as a light source is arranged on two sides or one side, which may be a long side or a short side, of the entire backlight. The cold cathode lamp is a line light source, and the LED is a point light source. In order to convert the light source into a surface light source, a light guide plate is needed. The light guide plate is generally made of high-transmittance acrylic plastic, and a surface of the light guide plate is very smooth and flat, so that most of the internal light is regularly totally reflected on its flat surface and not be emitted outside the light guide plate. A white dot is printed on the bottom of the light guide plate of the liquid crystal display. In the position where the light guide plate is printed with dots, the light is no longer regularly reflected but is emitted above the light guide plate. A density of dots at each position controls the light emitted from the light guide plate. The precisely designed light guide plate dots allow the incident light from both sides to spread evenly across the entire surface. Optical films are placed above the light guide plate. These optical films provide uniform light and concentrate large angles of light for frontal viewing.

The backlight is a kind of light source behind the liquid crystal display (LCD), and its lighting effect directly affects the liquid crystal display module (LCM) visual effect. The backlight is mainly made of a light source, a light guide plate, an optical film, a plastic frame, etc. The backlight has characteristics of high brightness, long life, and uniform illumination, and the backlight includes an edge lighting and a direct lighting depending on position of the light source.

The edge lighting is a single light source placed on a side of the display. The light guide plate is formed by injection molding without printing. The light guide plate is commonly used in small and medium-sized backlight modules below 30 inches, and the side light source has the characteristics of light weight, thin, narrow frame, and low power consumption. It is also a light source for mobile phones, tablet computers, and laptops. There are also large-size TV backlight modules adopting a sidelight structure.

As for oversized backlight modules with a bottom lighting, the sidelight structure has been unable to take advantage of weight, power consumption, and brightness, so a direct lighting structure without a light guide plate and the light source placed directly below the display is developed. The light source is emitted by a spontaneous light source, for example, a lamp tube, an LED, etc., and reflected by the reflective plate, and then uniformly diffused upward through the diffusion plate and then emitted on the front side of the display. Due to the large installation space, two or more lamps are used according to the size of the thin film transistor (TFT) panel, but it also increases the thickness, weight, and power consumption of the module, and its advantages are high brightness, good light viewing angle, and high light utilization efficiency, simple structure, etc., so it is suitable for LCD monitors and LCD TVs that are less demanding on portability and space requirements.

As the LCD module continues to move toward brighter, lighter, and thinner, researchers define a via hole in the backlight module to place the camera. In the via hole of the existing backlight module, the light behind the via hole of the light guide plate is less according to the propagation path of the light in the light guide plate, which results in a darkness of the via hole in the backlight module and low brightness uniformity of the entire surface of the light guide plate, and thus it affects optical property and the customer experience satisfaction. Accordingly, it is necessary to find a method to solve the problem that the brightness of the light guide plate is darkness behind the via hole, the brightness of an entire surface of the light guide plate is low, poor optical property, and poor customer experience.

### SUMMARY OF INVENTION

An object of the present invention is to provide a backlight module to solve the problem of a via hole of the backlight module, the brightness of the light guide plate behind the via hole is darkness, the brightness uniformity of entire surface is low, and poor optical property.

A backlight module includes a light guide plate, a frame body, and a light source. The frame body is disposed around the light guide plate. The light source is disposed between the light guide plate and the frame. A via hole is defined on the light guide plate. An outer convex is disposed on a side plate of the light guide plate away from the light source behind the via hole, and/or an inner recess is disposed on a side frame of the frame body away from the light source behind the via hole.

In one embodiment, a surface shape of the outer convex includes a circular-arc.

In one embodiment, a shape of the inner recess corresponds to a shape of the outer convex.

In one embodiment, a surface shape of the inner recess includes a circular-arc.

In one embodiment, backlight module further includes a backplate, a reflective plate. The reflective plate is disposed on the backplate, and the light guide plate is disposed on the reflective plate. An optical film is disposed on the light guide plate.

In one embodiment, backlight module further includes a light strip circuit board and a light shielding glue. The light strip circuit board is connected to the light source. The light shielding glue is disposed on the light strip circuit board.

In one embodiment, the optical film includes a lower diffusion plate, a prism plate, and an upper diffusion plate. The lower diffusion plate is disposed on the light guide plate. The prism plate is disposed on the lower diffusion plate. An upper diffusion plate is disposed on the prism plate.

In one embodiment, the light strip circuit board is connected to the frame body and the light guide plate through a double-sided tape.

A display device includes a backlight module.

In one embodiment, a surface shape of the outer convex includes a circular-arc.

In one embodiment, a shape of the inner recess corresponds to a shape of the outer convex.

In one embodiment, a surface shape of the inner recess includes a circular-arc.

In one embodiment, the display device further includes a backplate, a reflective plate, and an optical film. The reflective plate is disposed on the backplate, and the light guide plate is disposed on the reflective plate. An optical film is disposed on the light guide plate.

In one embodiment, the display device further includes a light strip circuit board and a light shielding glue. The light strip circuit board is connected to the light source. The light shielding glue is disposed on the light strip circuit board.

In one embodiment, the optical film includes a lower diffusion plate, a prism plate, and an upper diffusion plate. The lower diffusion plate is disposed on the light guide plate. The prism plate is disposed on the lower diffusion plate. The upper diffusion plate is disposed on the prism plate.

In one embodiment, the light strip circuit board is connected to the frame body and the light guide plate through a double-sided tape.

A backlight module and a display thereof are provided. An outer convex is disposed on a side plate of the light guide plate away from the light source behind the via hole, and/or an inner recess is disposed on a side frame of the frame body away from the light source behind the via hole.

The convex and recess forms a shape similar to a concave mirror, so that the light emitted by the light source can be reflected multiple times at the outer convex design, so that more light reaches behind of the via hole, thereby improving the brightness of the light guide plate behind the via hole, the brightness uniformity of the entire backlight module, optical property, and customer experience satisfaction.

### BRIEF DESCRIPTION OF DRAWINGS

In order to more clearly illustrate the technical solutions in the embodiments, the drawings described in the description of the embodiments are briefly described below. It is obvious that the drawings in the following description are only some embodiments of the present invention. Other drawings can also be obtained from those skilled persons in the art based on drawings without any creative effort.

FIG. 1 is a schematic view of a backlight module according to one embodiment of the present invention.

FIG. 2 is a plan view of a light guide plate and a frame body according to a first embodiment of the present invention.

FIG. 3 is a plan view of a light guide plate and a frame body according to a second embodiment of the present invention.

FIG. 4 is a plan view of a light guide plate and a casing according to a third embodiment of the present invention.

Reference numerals are described below:

reflective plate 1; light guide plate 2; optical film 3; frame body 4; light source 5; light strip circuit board 6; light shielding glue 7; double-sided tape 8; first side plate 21; second side plate 22; via hole 23; outer convex 24; first side frame 41; second side frame 42; and inner recess 43.

### DETAILED DESCRIPTION OF PREFERRED EMBODIMENTS

The preferred embodiments of the present invention are described in detail below with reference to the accompanying drawings. Those skilled persons in the art will easily understand how to implement the invention. The invention can be implemented by the embodiments, so that the technical content of the disclosure will be clear, so that those skilled persons in the art will understand how to implement the invention. The present invention may be accomplished in many different embodiments, and the scope of the invention is not limited to the embodiments described herein.

Directional terms mentioned in this application, such as “up,” “down,” “forward,” “backward,” “left,” “right,” “inside,” “outside,” “side,” etc., are merely indicated the direction of the drawings. Therefore, the directional terms are used for illustrating and understanding of the application rather than limiting thereof.

In the drawings, identical components are marked with the same reference numerals, and structural or components having similar functions are marked with similar reference numerals. Moreover, the size and thickness of each component shown in the drawings are arbitrarily shown for understanding and describing, and the invention does not limit the size and thickness of each component.

When a component is described as “on” another component, the component can be disposed directly on the other component. Also, one component is disposed on an intermediate component, and the intermediate component is disposed on another component. When a component is described as “installed” or “connected” to another component, it can be understood as directly “installed” or “connected” to another component.

### First Embodiment

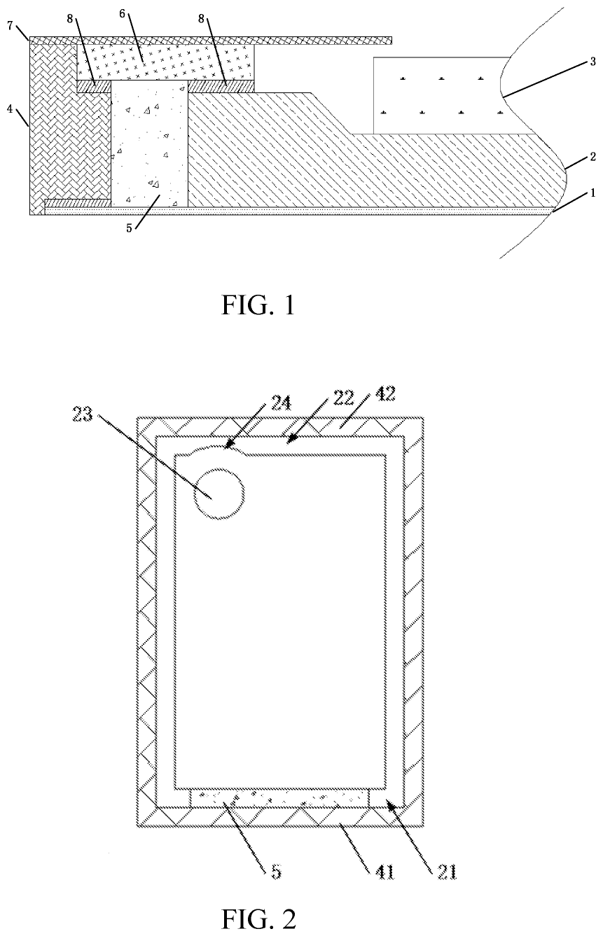

As shown in FIG. 1, it is a schematic view of a backlight module according to one embodiment of the present invention. The backlight module includes a backplate (not shown), a reflective plate 1, a light guide plate 2, an optical film 3, a frame body 4, a light source 5, a light strip circuit board 6, and a light shielding glue 7.

The reflective plate 1 is disposed on the backplate and is mainly used for reflecting leaking light from the bottom of the light guide plate 2 back into the light guide plate 2 for improving light availability.

As shown in FIG. 1 and FIG. 2, the light guide plate 2 is disposed on the reflective plate 1. A via hole 23 is defined on the light guide plate 2. The light guide plate 2 includes a first side plate 21 and a second side plate 22 corresponding to the first side plate 21. The second side plate 22 is a side plate of the light guide plate 2 away from the light source 5 behind the via hole 23.

As shown in FIG. 1 and FIG. 2, the frame body 4 is disposed around the light guide plate 2. The frame body 4 includes a first side frame 41 parallel to the first side plate 21 and a second side frame 42 parallel to the second side plate 22. The second side frame 42 is a side frame of the frame body 4 away from the light source 5 behind the via hole 23. The light source 5 is disposed between the first side plate 21 and the first side frame 41.

As shown in FIG. 2, an outer convex 24 is disposed on the second side plate 22 of the light guide plate 2 behind the via hole 23. A surface shape of the outer convex 24 is a circular-arc. The light is reflected multiple times at the outer convex 24 through the outer convex 24 having a circular-arc shape of the second side plate 22. Therefore, more light reaches behind the via hole, and the brightness of the light guide plate behind the via hole is improved, thereby improving the brightness uniformity of the entire backlight module, optical property, and customer experience satisfaction.

An optical film 3 is disposed on the light guide plate 2. Specifically, the optical film 3 includes a lower diffusion plate, a prism plate, and an upper diffusion plate. The lower diffusion plate is disposed on the light guide plate. The prism plate is disposed on the lower diffusion plate. The upper diffusion plate is disposed on the prism plate. A light shielding plate is disposed on the upper diffusion plate. The lower diffusion plate and the upper diffusion plate include a plurality of granular objects, and the light received by the light guide plate 2 may be diffused, so that the light is propagated toward the front of the display panel, thereby widening the viewing angle and concealing pattern formed on the light guide plate 2. The prism plate collects the diffused light so as to emit the diffused light at a certain angle, thereby improving the brightness of the display panel.

The light strip circuit board 6 is connected to the light source 5. The light strip circuit board 6 is connected to the frame body 4 and the light guide plate 2 through a double-sided tape.

The light shielding glue 7 is disposed on the light strip circuit board 6. It is mainly used to position the optical film 3 and shade a side of the frame 4 of the display device.

### Second Embodiment

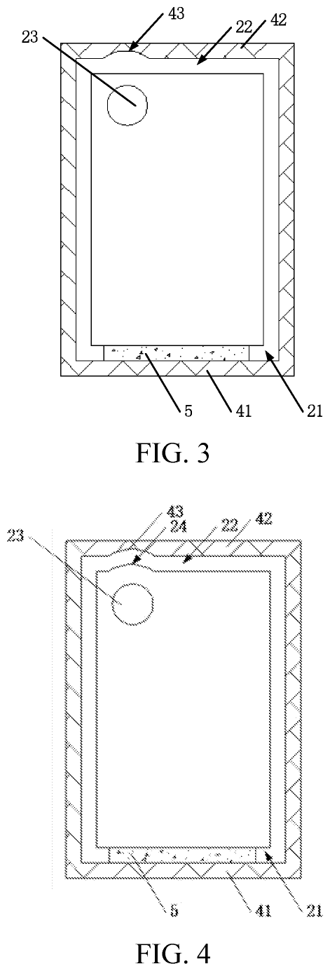

As shown in FIG. 3, the difference between the second embodiment and the first embodiment is that an inner recess 43 is disposed on a second side frame 42 of the frame body 4 away from the light source 5 behind the via hole 23. A shape of the inner recess 43 corresponds to a shape of the outer convex 24. A surface shape of the inner recess 43 includes a circular-arc.

The light is reflected multiple times at the inner recess 43 through the he inner recess 43 of the frame body 4. Therefore, more light reaches behind the via hole, and the brightness of the light guide plate behind the via hole is improved, thereby improving the brightness uniformity of the entire backlight module, optical property, and customer experience satisfaction.

### Third Embodiment

As shown in FIG. 4, the difference between the third embodiment and the second embodiment is that an outer convex 24 is disposed on a second side plate 22 of a light guide plate 2 away from the light source 5 behind the via hole 23. An inner recess 43 is disposed on a second side frame 42, which corresponds to the outer convex 24, of the frame body 4 away from the light source 5 behind the via hole 23.

A shape similar to a concave mirror is formed through the circular-arc outer convex 24 of the second side plate 22 and circular-arc the inner recess 43 of the second side frame 42. The light is reflected multiple times at the convex and recess, and more light reaches behind the via hole, thereby improving the brightness of the light guide plate behind the via hole, the brightness uniformity of the entire backlight module, optical property, and customer experience satisfaction.

A display device is also provided. The display device includes above backlight module. Since the backlight module has the same structure and the same technical effect, it is not be described herein

The backlight module and the display device provided are described in detail above. It is understood that the exemplary embodiments described herein are considered as illustrative only, and are not intended to limit the invention. Descriptions of features or aspects in each exemplary embodiment should generally be considered as suitable features or aspects in other exemplary embodiments. While the invention has been described with reference to the preferred embodiments thereof, various modifications and changes can be made by those skilled persons in the art. The invention is intended to cover various modifications within the scope of the appended claims.

The above are only the preferred embodiments of the present invention, and are not intended to limit the present invention. Any modifications, equivalent substitutions and improvements made within the spirit and scope of the invention are included within the scope of the invention.

What is claimed is:

1. A backlight module, comprising:
a light guide plate;
a frame body, wherein the frame body is disposed around the light guide plate;
a light source, wherein the light source is disposed between the light guide plate and the frame body; and
a via hole defined on the light guide plate;
wherein an outer convex is disposed on a side plate of the light guide plate away from the light source behind the via hole, and/or an inner recess is disposed on a side frame of the frame body away from the light source behind the via hole.

2. The backlight module according to claim 1, wherein a surface shape of the outer convex comprises a circular-arc.

3. The backlight module according to claim 1, wherein a shape of the inner recess corresponds to a shape of the outer convex.

4. The backlight module according to claim 3, wherein a surface shape of the inner recess comprises a circular-arc.

5. The backlight module according to claim 1, further comprising:
a backplate;
a reflective plate, wherein the reflective plate is disposed on the backplate, and the light guide plate is disposed on the reflective plate; and
an optical film disposed on the light guide plate.

6. The backlight module according to claim 1, further comprising:
a light strip circuit board, wherein the light strip circuit board is connected to the light source; and
a light shielding glue, wherein the light shielding glue is disposed on the light strip circuit board.

7. The backlight module according to claim 5, wherein the optical film comprises:
a lower diffusion plate, wherein the lower diffusion plate is disposed on the light guide plate;
a prism plate, wherein the prism plate is disposed on the lower diffusion plate; and
an upper diffusion plate disposed on the prism plate.

8. The backlight module according to claim 6, wherein the light strip circuit board is connected to the frame body and the light guide plate through a double-sided tape.

9. A display device comprising the backlight module of claim 1.

10. The display device according to claim 9, wherein a surface shape of the outer convex comprises a circular-arc.

11. The display device according to claim 9, wherein a shape of the inner recess corresponds to a shape of the outer convex.

12. The display device according to claim 11, wherein a surface shape of the inner recess comprises a circular-arc.

13. The display device according to claim 9, further comprising:
a backplate;
a reflective plate, wherein the reflective plate is disposed on the backplate, and the light guide plate is disposed on the reflective plate; and
an optical film disposed on the light guide plate.

14. The display device according to claim 9, further comprising:
a light strip circuit board, wherein the light strip circuit board is connected to the light source; and
a light shielding glue, wherein the light shielding glue is disposed on the light strip circuit board.

15. The display device according to claim 13, wherein the optical film comprises:
a lower diffusion plate, wherein the lower diffusion plate is disposed on the light guide plate;
a prism plate, wherein the prism plate is disposed on the lower diffusion plate; and
an upper diffusion plate disposed on the prism plate.

16. The display device according to claim 14, wherein the light strip circuit board is connected to the frame body and the light guide plate through a double-sided tape.
